(19) United States
(12) Patent Application Publication
(10) Pub. No.: US 2004/0258874 A1
(43) Pub. Date: Dec. 23, 2004

(54) Surface coverings containing styrene polymers

(76) Inventor: Peter Desai, Roswell, GA (US)

Correspondence Address: KILYK & BOWERSOX, P.L.L.C., 53 A EAST LEE STREET, WARRENTON, VA, 20186, US

(21) Appl. No.: 10/384,432

(22) Filed: Mar. 7, 2003

Related U.S. Application Data
(60) Provisional application No. 60/362,493, filed on Mar. 7, 2002.

(51) Int. Cl. B32B 3/02; B32B 33/00

(52) U.S. Cl. 428/95; 428/86; 428/88

(57) ABSTRACT

Surface coverings, such as carpet, are described which contain at least one styrene polymer in the backing layer or elsewhere. A preferred surface covering is a carpet such as a modular carpet tile. A preferred styrene polymer is styrene-butadiene-styrene polymers. Methods of forming the surface coverings are further described.

This application claims the benefit under 35 U.S.C. § 119(e) of prior U.S. Provisional Patent Application No. 60/362,493 filed Mar. 7, 2002, which is incorporated in its entirety by reference herein.

### BACKGROUND OF THE INVENTION

The present invention relates to surface coverings such as carpets, wood, plastic, ceramic, resilient, vinyl, or laminate flooring. The present invention more particularly relates to the use of certain types of polymers as one or more layers in surface coverings and methods of making the same.

Currently, many surface coverings are made with at least one layer containing a vinyl-containing polymer such as polyvinyl chloride (PVC). The use of PVC and other similar polymers are becoming less desirable for environmental reasons. For instance, when the polyvinyl chloride burns, it generates toxic fumes and HCI. Furthermore, the PVC, when used in floors, may emit undesirable odors due to the contact of the PVC with certain materials in the environment such as materials found on subfloors. Because these adhesives need to be plasticizer resistant, PVC backed carpet tiles can not be installed over old cut back adhesive because plasticization occurs whereas styrene backed carpet tiles of the present invention can be installed over old cut back adhesive. Also, PVC backed products require special adhesives for installation. Accordingly, more desirable materials that can be used as a substitute to PVCs and which are more environmentally friendly and inexpensive would be desirable in the industry.

The commercial carpet market in the United States is approximately 80% 12 ft. wide broadloom carpets and 20% modular tiles and 6 ft. wide roll goods. The most popular modular size in the U.S. is 18″×18″ and to a much lesser extent 24″×24″ and 36″×36″ modular sizes are also used. Modular tiles are predominantly vinyl backed.

The modular tiles are gaining more and more of the market share in the office environment because: (1) Modular tiles allow easy access to subfloor for utilities; (2) There is less disruption in office work during installation or replacement; (3) It is easy to reconfigure modular furniture in open office planning situations with carpet modules; (4) There is ease of transport in multi-story buildings; (5) Unlimited design flexibility; (6) Easy to install and remove; (7) Durable and cost effective; (8) Ability to replace damaged tile selectively; and (9) High performance.

The most predominantly used material for 6 ft. wide roll goods in the U.S. is based on polyvinyl chloride, often referred to as “vinyl”.

The 6 ft. vinyl backed roll goods are also increasing their market share in the healthcare, institutional, and other markets due to their higher performance over broadloom carpet, their ability to provide a wall to wall moisture barrier due to chemically weldable properties of vinyl at carpet seams, superior dimensional stability, easy to transport, install and remove carpet, as well as it's lower cost based on life cycle.

The carpet tiles and 6 ft. wide roll goods have been growing rapidly in the last 25 years. They are different in properties and end use applications compared to traditional 12 ft. wide SBR latex backed carpets. The SBR latex chemistry is an aqueous system (water based) whereas the vinyl chemistry is non-aqueous. SBR latex backed carpets are hard backed and as such, they are glued to the floor or installed over a cushioned padding. SBR latex backed carpet as compared to vinyl backed modular tiles or 6 ft. roll goods are in a totally different category. This is due to the fact that one can not take SBR latex backed 12 ft. wide carpet and cut it into 18″×18″ carpet tiles or 6 ft. wide roll goods and expect the same functionality.

The construction and components of carpet tiles and 6 ft. vinyl backed roll goods are completely different. The vinyl backed products are engineered products with a different cross section and use a non-woven fiberglass fleece or scrim.

The unique properties of vinyl backed products such as superior dimensional stability, double moisture barrier, high wet tuft bind, chemically weldable carpet seams, ability to withstand repeated wet cleanings are not exhibited by 12 ft. wide SBR backed carpet and hence it is clear that SBR backed 12 ft. wide broadloom carpet and 18″×18″ vinyl backed carpet tiles or 6 ft. wide vinyl backed roll goods are different products. The modular tiles and 6 ft. roll goods are offered with hardback backings as well as cushioned backings.

Recently, cushion backed products are increasing in demand because they offer better under foot comfort and hence better ergonomics as well as better appearance retention on the face of the carpet.

The 6 ft. wide, vinyl cushion backed roll goods and 18″×18″ vinyl cushion backed modular products are available in the market place today. These vinyl foam backed products predominantly use closed-cell chemical foam. The closed-cell foams are achieved by the use of a blowing agent which blows the original thickness by 3 to 4 times when subjected to relatively high temperatures generally between 380° F.-400° F. Since the production of closed-cell chemical foam generally requires relatively high blow ratios (3-4) and high temperatures it can not be applied and be blown directly on the back of the carpet. Hence, production on vinyl foam backed modules and 6 ft. roll goods is currently achieved in the following three steps.

Step—1 Apply pre-coat to the tufted carpet.

Step—2 Produce closed-cell PVC foam as a separate process.

Step—3 Laminate previously pre-coated carpet with pre-manufactured PVC foam closed-cell PVC foam sheet.

Further, there are some disadvantages of this three step process. They are as follows:

(1) Poor dimensional stability because the process requires hot lamination at elevated temperatures (approx. 350° F.-360° F.) of vinyl foam to the pre-coated carpet under extremely well controlled tension conditions. In actual manufacturing it is very difficult to control precise temperatures, tensions, and orientation of the textile product, such as tufted carpet without distortion.

Further, this process is not capable of incorporating non-woven fiberglass fleece or scrim in the secondary backing composite. The net result is this process produces a dimensionally unstable product. In order to overcome this difficulty, the carpet is sold with a very aggressive, factory applied adhesive. This adhesive is so aggressive that removal of the carpet is time consuming and very expensive. Many times, the primary backing is removed but the secondary backing still adheres to the sub-floor, due to the poor delamination strength and/or dimensional stability.

(2) The delamination strength of the secondary foam backing is often low and uneven due to difficulty in precise process control.

(3) The chemically blown foam still has some open cells which is confirmed by moisture absorption tests (usually 6-10%).

The present invention provides advantages and overcomes many of the disadvantages of current surface coverings.

### SUMMARY OF THE INVENTION

A feature of the present invention is to provide alternatives to vinyl containing backing layers.

Another feature of the present invention is to provide a cost effective replacement to vinyl-containing backing layers.

A further feature of the present invention is to provide a material which will provide the desired dimensional stability with respect to a modular carpet tile.

Another feature of the present invention is to provide peel and stick properties to flooring products by altering the final layer of the backing, e.g., making it behave like a pressure sensitive, releasable adhesive. This can be done by changing the ratio of end block to mid block resins and plasticizer/oil in the composition used to form the layer.

Another feature of the present invention is to provide high performance 12 ft wide broadloom carpet that can be installed over existing multi-purpose latex adhesive on floor, resulting in savings of clean up cost of existing adhesive on the floor, when old carpet is pulled up from the floor.

A further feature of the present invention is to provide surface coverings which satisfy physical property requirements and yet is more environmentally friendly than PVC.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates to a surface covering which has a backing layer containing a styrene polymer, such as a styrene-butadiene-styrene polymer (SBS) or similar polymer.

The present invention also relates to a carpet, such as a carpet tile, having a primary backing having textile fibers extending upwardly from the primary backing and forming a surface, an adhesive or polymeric pre-coat layer located below and affixed to the primary backing; an intermediate backing located below and affixed or at least partially embedded into the adhesive or polymeric pre-coat layer; and a bottom or backing layer located below and affixed to the intermediate backing. For purposes of the present invention, the bottom or backing layer and/or another layer contains a styrene polymer or derivatives thereof. Preferably, the intermediate backing also contains a styrene polymer which can be the same or different from the polymer contained in the bottom or backing layer. Also, preferably a reinforcement layer, such as a non-woven fiberglass layer is located between the intermediate backing and the bottom or backing layer. The reinforcement layer can be at least partially embedded into the intermediate backing and/or the bottom or backing layer.

The present invention further relates to a textile substrate having a primary backing layer, an adhesive or polymeric pre-coat layer, an intermediate backing layer, and a bottom or backing layer as described above and preferably a reinforcement layer as described above and located between the intermediate backing layer and the bottom layer.

Also, the present invention relates to methods for preparing a textile substrate which involves forming the above-described layers in order to form the textile substrate or carpet tile or other surface covering.

It is to be understood that both the foregoing general description and the following detailed description are exemplary and explanatory only and are intended to provide a further explanation of the present invention, as claimed.

The accompanying drawings which are incorporated in and constitute a part of this application, illustrate several embodiments of the present invention and together with the description serve to explain the principles of the present invention.

### BRIEF DESCRIPTION OF THE DRAWINGS

FIG. 1 is a cross-sectional view of a surface covering according to one embodiment of the present invention.

FIG. 2 depicts a roller coater set up for one embodiment of the present invention.

### DETAILED DESCRIPTION OF THE PRESENT INVENTION

The present invention relates to surface coverings that have at least one layer containing a styrene polymer, such as a styrene-butadiene-styrene polymer or related or similar polymer. Preferably, the surface covering is a textile substrate such as a carpet and more preferably a carpet tile, such as a modular carpet tile. Preferably, the layer that contains the styrene polymer is a backing, also known as a backing layer. This polymer layer can also be used as a secondary backing layer or an intermediate backing layer for a surface covering. Various coatings or layers are discussed herein, and unless stated otherwise, are preferably of a substantially uniform thickness and can be applied using techniques known to those skilled in the art.

For purposes of the present invention, a surface covering can be any surface covering which makes use of a backing and/or intermediate layer, such as a floor covering, wall covering, ceiling covering, countertop covering, and the like. Examples of floor coverings include, but are not limited to, textile substrates, such as carpets, and resilient flooring, such as vinyl flooring or vinyl surface coverings. Particularly preferred examples of textile substrates are hard backed and cushion backed textile substrates. While the present invention will be described with respect to the preferred embodiment which is floor coverings, and in particular textile substrates and resilient flooring, the present invention can be applied to other types of surface coverings containing backing and/or intermediate layers in view of the disclosure herein.

Preferably, the textile substrate is a broadloom carpet, modular tile, or a wide roll carpet (e.g. 6 ft. wide). Most preferably, the textile substrate is tile or 6 ft. roll goods.

The textile substrate comprises textile fibers defining a fibrous face, a primary backing to which the textile fibers are secured, and a secondary or intermediate backing secured to the primary backing. For purposes of the present invention, the term “textile substrate” relates to, but is not limited to, a fiber, web, yarn, thread, sliver, woven fabric, knitted fabric, non-woven fabric, upholstery fabric, tufted carpet, and piled carpet formed, from natural and/or synthetic fibers. For purposes of the present invention, any conventional textile fibers can be used to form the fibrous face. For instance, the textile fibers can be synthetic or natural materials, such as polymeric materials such as nylon and the like. The primary backing or tufting substrate can be a woven or non-woven synthetic material. Any conventional tufting substrate can be used for purposes of the present invention.

The backing or backing layer for purposes of the present invention can be any layer or substrate which preferably is in contact with the sub-surface, such as a subfloor. An intermediate layer for purposes of the present invention is preferably any layer located between the backing layer and the primary backing.

Located beneath the primary backing is preferably an adhesive precoat layer which is preferably a polymeric type layer. Preferably, the adhesive precoat is a SBR latex layer. This layer assists in securing the textile fibers to the primary backing. In a preferred embodiment of the present invention, an intermediate layer is located beneath the adhesive precoat layer. This intermediate layer is preferably a secondary coating which can be a polymeric coating such as a PVC or other conventional polymeric materials used for this layer and known to those skilled in the art. Alternatively, the precoat layer is a styrene polymer as shown, for instance, in one of the examples. Preferably, as discussed below, this intermediate layer, if present, is a styrene polymer. In this preferred embodiment, a stabilizer layer is located beneath this intermediate layer. The stabilizer layer can also be known as a reinforcement layer and is preferably a non-woven fiberglass layer. Located beneath this reinforcement layer is the final secondary coating which for purposes of the present invention can be considered the backing layer or secondary backing. Preferably, the secondary backing is made from at least a styrene polymer such as a styrene-butadiene-styrene polymer or related types of polymers. For purposes of the present invention, any embodiment can contain more than one type of layer, e.g., more than one precoat layer, more than one intermediate layer, and so on. Any combination is possible.

A preferred styrene polymer is a styrene-butadiene-styrene polymer (SBS) polymer which is preferably a KRATON™ polymer. Preferably the polymer or elastomer is a KRATON D or G polymer. There are numerous grades of KRATON™ polymers and any one of these can be used in the present invention to form one or more layers of the surface covering and preferably the secondary backing. Other related polymers in the KRATON series include, but are not limited to, styrene-isoprene-styrene polymers, styrene-ethylene/butadiene-styrene, and styrene-ethylene/propylene-styrene polymers. Furthermore, KRATON IR polymers can be used as well. Many of the KRATON polymers are characterized by their polystyrene content. Preferred KRATON polymers that can be used in the present invention include KRATON™ D1101, KRATON™ D4141, and the like. Other KRATON polymers can be used wherein the variation in the block styrene content in percent mass is varied as well as the hardness based on Shore A, 30s. Essentially, the KRATON D polymers have an unsaturated rubber mid-block (styrene-butadiene-styrene, SBS and styrene-isoprene-styrene SIS). The KRATON G polymers have a saturated mid-block (styrene-ethylene/butylene-styrene, SEBS and styrene-ethylene/propylene SEP). The styrene polymers which could be utilized as the thermoplastic polymer are preferably the various S-(E/B)-S block copolymers wherein the sphere S is made from a vinyl substituted aromatic having from 8 to about 12 carbon atoms as noted above, with styrene being preferred, and the center block is a saturated ethylene-butylene rubber. Such a block copolymer is generally known as hydrogenated KRATON G and is available from the Shell Chemical Company. Another class of styrene polymers is the various S-B-S block copolymers where the S block is made from a vinyl substituted aromatic having from 8 to about 12 carbon atoms such as styrene, alphamethylstyrene, and the like, with the styrene being preferred, and the B block is made from a conjugated diene having from 4 to 8 carbon atoms such as butadiene, isoprene, hexadience, and the like, with butadiene being preferred. Other suitable styrene polymers are styrene block polymers, such as styrene-hydrocarbon-styrene block polymers, where the hydrocarbon is saturated or unsaturated. With respect to these polymers, a layer can be formed by extrusion techniques using these polymers that are commercially available. In addition, these polymers can contain other components such as stabilizers, oil extenders, fillers, other thermoplastic resins, thermoset resins, and the like to form the styrene polymer composition or formulation. The KRATON™ type polymers are sometimes considered elastomers. Further, these types of polymers typically do not need any vulcanizing.

Also, the styrene polymers can be formulated as polymeric alloys containing any combination of thermoplastic and/or thermoset resins such as LDPE, HDPE, bitumen, EVA, olefins, polyurethanes, PVC, polyacrylics, and the like. Typically, these other polymers that are added to form an alloy can range from about 1% to about 40% by weight or more based on the weight of the formulation used to form the particular layer in the surface covering.

The secondary backing preferably contains the styrene polymer composition in the amount of from about 20 to 50 ounces per square yard and other amounts can be used. Preferably, the amount is about 40 ounces per square yard. The thickness of the secondary backing is from about 20 to about 50 mils, more preferably from about 30 to about 40 mils, and most preferably about 35 mils.

In the present invention, as indicated above, one option is to also use a styrene polymer as the intermediate layer or secondary coating located between the adhesive precoat layer and the backing layer. The secondary coating or intermediate layer can contain the same or different type of styrene polymer as used in the backing layer. Preferably, the same thicknesses and amounts of the styrene polymer can be used in this layer as in the backing layer described above.

With respect to the stabilizer layer, or reinforcement layer, the non-woven fiberglass is preferably a fiberglass fleece or sheet which is preferably 1.0 pound to about 2.0 pound per 100 square feet, e.g., 1.4 lb./100 ft.² which is available from Johns Manville. Other stabilizer layers or materials can be used.

As indicated above, the layers containing styrene polymers can be formed by extrusion techniques, such as extruding at temperatures of from about 350° F. to about 425° F.

Furthermore, the adhesive precoat layer can also be formed with a styrene polymer as well. Again, this styrene polymer can be the same or different from the styrene polymer used in the backing layer and optionally the intermediate layer.

In each case, each layer as described above is affixed in some manner such as by roller coating, casting or extruding the various layers on a previously formed layer, the use of adhesive, or other means conventional in the art. As an alternative to using the primary backing as the substrate in which all other layers are applied thereto, it is certainly within the bounds of the present invention to make any layer of the surface covering first and then add other desirable layers to the top and/or bottom surface of the first layer made. For instance, the secondary or final backing layer can be made first and all of the other layers applied thereto.

The backing layer can be a cushion-back or a hard back backing. In more detail, the backing can be a solid styrene polymer backing or a foamed backing. Generally, the backing contains a sufficient amount of at least one blowing agent and optionally a plasticizer and can include other ingredients conventionally used in backings.

Chemically expanded thermoplastic foamed backings can be used as the secondary or intermediate backing and can be prepared by casting or extruding a thermoplastic resin plastisol containing a blowing agent onto the back of the primary backing and heating to expand and fuse the plastisol. Alternatively, a pre-blown foamed secondary backing can be laminated, such as by heat, to the primary backing. The solid thermoplastic secondary backing can be similarly prepared by extruding, casting, or by lamination. For instance, a polyurethane foam layer can be used, or polymeric layer such as described in U.S. Pat. Nos. 5,204,155 and 5,545,276, incorporated in their entirety by reference herein.

Conventional blowing agents can be used and include, but are not limited to azodicarbonamite, oxybissulfonyl hydroxide, substituted thiatriazole, and the like such as the ones described in U.S. Pat. No. 3,661,691 incorporated its entirety by reference herein.

Any type of carpet can be formed using the present invention such as tiles, six foot rolled carpet, broadloom carpet and the like. Furthermore, peel and stick conventional technology can be used in order to form an adhesive backing on the back of the carpet, preferably carpet tile. This adhesive can be a releasable adhesive which is conventional in the carpet technology. Unlike many other peel and stick applications, the present invention, especially when a styrene polymer backing is used does not need to use an adhesive which prevents plasticizer migration since this is not a problem with styrene backings. Accordingly, a host of different types of peel and stick adhesives can be used without limitation unlike other carpet tile technologies where plasticizer migration can be a problem and therefore certain types of adhesives must be used to block plasticizer migration. Furthermore, as shown in one of the examples, the adhesive can be a styrene polymer type adhesive which is preferably a Kraton type adhesive, which is commercially available. This type of adhesive especially when a styrene polymer backing is used would be beneficial from the standpoint of similar chemistries. Alternatively, the styrene backing can be made tacky by adjusting the ratio of end block to mid block resins and plasticizer/oil in the composition. One skilled in the art of styrene chemistry can do this.

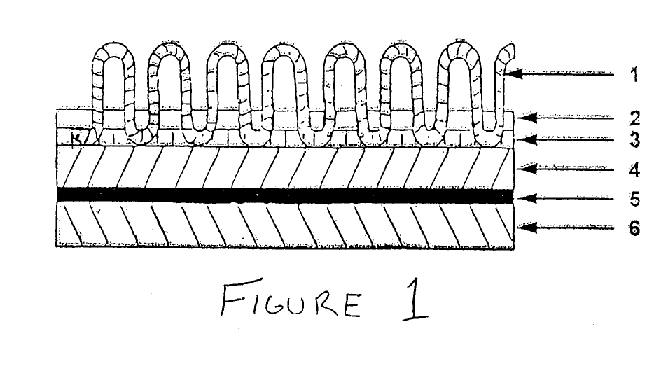

As shown in FIG. 1, an exploded cross-sectional view of a preferred surface covering is depicted. As can be seen, textile fibers 1 are tufted into a tufting substrate or primary backing 2. An adhesive precoat layer 3 is then applied to the tufting substrate 2 in order to secure the textile fibers 1 in the tufting substrate 2. A secondary coating or intermediate layer 4 is located beneath the adhesive precoat 3. Located beneath the intermediate layer 4 is a stabilizer or reinforcement layer 5. Located below the reinforcement layer 5 is the backing layer or secondary backing layer 6. Certainly, for purposes of the present invention, additional layers not shown in FIG. 1 can be used such as additional reinforcement layers and additional intermediate layers and additional backing layers which can be the same or different.

The modular carpet tiles of the present invention meet or exceed all requirements for commercial carpet tiles, including the important dimensional stability, wherein the tiles preferably have a dimensional stability of from about ±0.02% to about ±0.15%.

The various surface coverings are described in U.S. Pat. Nos. 6,291,078; 6,228,463; 6,218,001; 6,114,008; 5,961,903; and 5,891,564 can be adapted to receive at least one layer containing the styrene polymer layer. In each of these patents, the backing layer or substrate and/or another layer, such as a strengthening layer can have a layer comprising the styrene polymer. Thus the present invention can be used in vinyl flooring products, laminate flooring products, thermoplastic planks, wood products, ceramic tile, and the like. In each of these products, the substrate or other similar type of layer can be a styrene polymer as described above.

The present invention will be further clarified by the following examples, which are intended to be exemplary of the present invention.

### EXAMPLES

A 18″×18″ carpet tile was prepared by using a SBR latex as the pre-coat layer in an amount of approximately 28 ounces per square yard. Also, the secondary backing layer as well as the intermediate layer contained KRATON™ D 4141, wherein the backing layer and intermediate layer had a combined amount of 80 ounces per square yard of KRATON™ formulation used to form these layers. Located between the intermediate layer and the backing layer was the reinforcement layer which was a non-woven fiberglass mat from Johns Manville which was 1.4 lbs./100 ft.² in thickness and amount.

In forming the modular tile, the textile fibers were inserted into a tufting substrate and then an SBR latex adhesive precoat was applied using a roll coater. The layer was then subjected to heat to cure the precoat layer. Then the intermediate or secondary coating containing the KRATON formulation described below was extruded at a temperature of about 400° F. onto the adhesive precoat and then a non-woven fiberglass stabilizer layer was placed on this secondary coating. Afterwards, the secondary backing layer containing the same KRATON formulation as the intermediate layer was then extruded at about 400° F. onto the stabilizer layer to form the modular tile of the present application. The particular formulation for the secondary backing layer and the intermediate layer was as follows:

COMPOUNDING FORMULA HS-128-3

| COMPONENT | % Wt. | Wt. (lbs.) |
|---|---|---|
| Styrene polymer - KRATON D4141 | 19.50 | 2340 |
| Calcium Carbonate Filler - VICRON 25-11 | 69.64 | 8357 |
| Oil extender - Shellflex 371 | 9.75 | 1170 |
| Stabilizer - Irganox 1010 | 0.56 | 67.2 |
| EVA (Black) Polymer | 0.56 | 67.2 |

This modular tile was then subjected to various testings. It was determined that the dimensional stability of the product met modular stability requirements by having a dimensional stability that was ±0.02% to ±0.15%. The flammability of the product using ASTM 648, radiant panel test, had a Class I rating. The NBS smoke test was acceptable as determined by ASTM 662.

The tuft bind as determined by ASTM D-1335 was acceptable in having a tuft bind of 20.0 pounds.

The modular tile also had an acceptable resistance to surface flammability. The TVOCS met CRI green label and had less than 0.5 mg/m² hr. The flatness of the product passed procedures I and II. The cosmetics and color of the modular tile were acceptable as compared to conventional commercially available modular tiles.

Accordingly, the use of the styrene polymers, such as KRATON type materials, in surface coverings was acceptable.

### Example 2

Any textile or non-textile substrate can be coated with a Kraton hot melt compound.

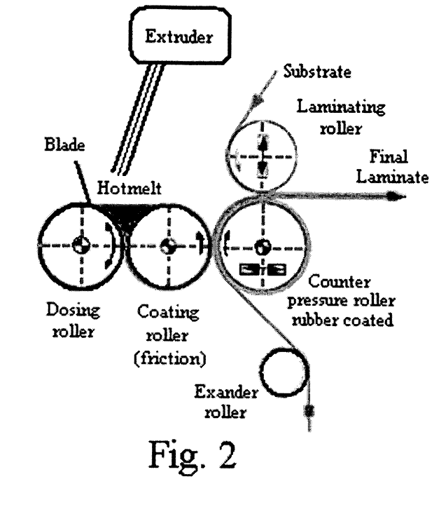

In this example, a tufted greige carpet was precoated with a Kraton hot melt compound using a Lacom multi roller coating/laminating machine. This machine is made by Lacom Vertriebs, GmbH of Germany. FIG. 2 shows the process.

Simultaneously, a polyurethane foam of approximately 0.125″ thickness (preferred thickness range can be from 0.100″-2.0″) with 1.5 ozs/sq.yd. (preferred range can be 1.0 ozs/sq.yd.-4.0 ozs/sq.yd.) on one side and 11 pick woven polypropylene scrim (preferred range can be 9 pick to 15 pick) on the other side, made on a separate process, is laminated to the Kraton precoated carpet.

As shown in FIG. 2, the laminating roll presses the fiberglass side of the polyurethane foam into the Kraton hot melt compound.

If peel and stick properties are desired, then an approximately 10 mil thick layer (preferred range can be 5-50 mils) of Kraton based pressure sensitive adhesive can be applied on the woven polypropylene scrim.

The carpet was then cut into 18″×18″ tiles.

### Example 3

FORMULATION #1

| ITEM | PERCENT (% by weight) | WEIGHT (lbs) |
|---|---|---|
| KRATON D-1102 | 13.33 | 427 |
| PICO 6100 | 15.55 | 498 |
| WINGTACK 86 | 8.88 | 284 |
| SHELL FLEX 371 (OIL) | 6.66 | 213 |
| ATH | 55.55 | 1778 |
| TOTALS | 99.97 | 3200 lbs |

FORMULATION #2

| ITEM | PERCENT (% by weight) | WEIGHT (lbs) |
|---|---|---|
| KRATON D-1102 | 12.0 | 384 |
| ATEVA 2430 | 1.33 | 43 |
| PICO 6100 | 15.55 | 498 |
| WINGSTACK 86 | 8.88 | 284 |
| SHELL FLEX 371 (OIL) | 6.66 | 213 |
| ATH | 55.55 | 1778 |
| TOTALS | 99.97 | 3200 |

At the present time, approximately 60-70% of all commercial 12 ft. wide broadloom carpet in the U.S. is made by water based SBR latex chemistry and woven polypropylene as the secondary backing. The backing system is a relatively low cost system but does not have superior physical properties and product failures are above average. SBR latex based carpets are not dimensionaly very stable, have lower physical properties such as turf bind, delamination, and edge ravel. Further it is not a moisture barrier product and hence it is not used in the health care industry. It also shows a stain wick back property because of the water based precoat.

Further, SBR latex precoated carpets are not very flexible in cold temperatures which makes installation somewhat difficult.

The present invention can use a styrene based non-aqueous hot melt composition which, at only slightly higher cost, removes all of the disadvantages of SBR latex (water based) backed carpets.

In this example, the styrene based broadloom carpet was coated with formulation #1 and formulation #2 with good results.

The amount of compound applied varied between 30 ozs/sq.yd. to 70 ozs/sq.yd., depending on the construction of the carpet.

The formulation #1 or #2 was fed into a twin screw extruder, such as made by Werner and Pfleiderer of Germany, and extrudate was directly applied on the back of the carpet using a Lacom multi roller hot melt coater/laminator as shown in FIG. 2. Alternatively, the formulation can be made in the above extruder in pellet form using under water pelletizer techniques and then the pellets are fed into an extruder and then applied to the back of the carpet. After the hot melt precoat was applied, the secondary backing, which is a woven polypropylene of 11 pick was laminated to the Kraton hot melt. The preferred range can be −7 pick-20 pick. If the peel and stick properties are desired a special Kraton based adhesive is applied on the top of the secondary backing. The thickness of the adhesive is 20-60 mils depending on the bond strength required.

The resultant product showed the following test results

Style-Mannington-Strategies

Precoat weight—33 ozs/sq.yd.

Tuft bind dry—15.8 lbs.

Tuft bind wet—16.1 lbs.

Moisture barrier-pass

Radiant panel—0.47 watts/cm²-class-I

NBS smoke (flaming mode)—131 (pass=450 or less)

The Test Results of Kraton Modular:

Style-Mannington-Strategies

Precoat—35 ozs/sq.yd. Formula #2

1^{st} coat 35 ozs/sq.yd. hard back formula HS-128-3

stabilizer 1.5 ozs/sq.yd. non-woven fiberglass from Johns Manville

2^{nd} coat 35 ozs/sq.yd. hard back same as 1^{st} coat.

The coating was done on a Lancom hot melt multi roller coating/laminating machine.

Test Data

Anchor test-dimensional stability

Length—+0.069%

Width—+0.036%

Tuft bind—19.9 lbs.

Radiant panel—(flammability) 0.98 watts/cm² (class-1)

NBS Smoke-flaming—168

Non-flaming—161

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A surface covering comprising a backing layer, wherein said backing layer comprises at least one styrene polymer.

2. The surface covering of claim 1, wherein said styrene polymer is a styrene-butadiene-styrene polymer.

3. The surface covering of claim 1, wherein said styrene polymer comprises a KRATON polymer.

4. The surface covering of claim 1, wherein said surface covering is a carpet tile.

5. A carpet comprising a primary backing having textile fibers extending upwardly from the primary backing and forming a surface;
at least one adhesive or polymeric precoat layer located below and affixed to a primary backing;
at least one intermediate backing located below and affixed or at least partially embedded into said adhesive or polymer pre-coat layer;
and a backing layer located below and affixed to the intermediate backing, wherein said backing layer comprises a styrene polymer.

6. The carpet of claim 5, wherein said carpet is a modular carpet tile.

7. The carpet of claim 5, wherein said styrene polymer comprises at least one KRATON polymer.

8. The carpet of claim 5, wherein said styrene polymer comprises a styrene-butadiene-styrene polymer.

9. The carpet of claim 5, wherein said styrene polymer comprises a styrene-hydrocarbon-styrene block polymer.

10. The carpet of claim 5, wherein said styrene polymer comprises a styrene-isoprene-styrene block polymer, a styrene-ethylene/butylene-styrene block polymer, a styrene-ethylene/propylene block polymer, and combinations thereof.

11. The carpet of claim 5, wherein said styrene polymer further comprises at least one additional thermoplastic resin or thermoset resin or both.

12. The carpet of claim 11, wherein said thermoplastic resin or thermoset resin is LDPE, HDPE, bitumen, EVA, an olefin, a polyurethane, a PVC, or combinations thereof.

13. The carpet of claim 11, wherein said thermoplastic resin or thermoset resin is present in an amount of from about 1% to about 40% by weight based on the total weight the styrene polymer.

14. The carpet of claim 5, wherein said styrene polymer is present in an amount of from about 20 to 50 ounces per square yard.

15. The carpet of claim 5, wherein said styrene polymer is present in an amount of about 40 ounces per square yard.

16. The carpet of claim 5, wherein said backing layer has a thickness of from about 20 to about 50 mils.

17. The carpet of claim 5, wherein said adhesive or polymeric pre-coat layer comprises a SBR latex and said intermediate layer comprises at least one styrene polymer which is the same or different from said styrene polymer in said backing layer.

18. The carpet of claim 5, wherein a reinforcement layer is located between said intermediate backing and said backing layer.

19. The carpet of claim 18, wherein said adhesive or polymeric pre-coat layer comprises a SBR latex and said intermediate layer comprises a styrene polymer which is the same or different from said styrene polymer in said backing layer.

20. The carpet of claim 18, wherein said reinforcement layer comprises a non-woven fiberglass layer.

21. The carpet of claim 19, wherein said reinforcement layer comprises a non-woven fiberglass layer.

22. The carpet of claim 5, wherein said styrene polymer further comprises a filler, oil extender, stabilizer, thermoplastic resin, thermoset resin, or combinations thereof.

23. The carpet of claim 5, wherein said adhesive or polymeric pre-coat layer comprises at least one styrene polymer and said intermediate layer comprises at least one styrene polymer which is the same or different from said styrene polymer in said backing layer.

24. The carpet of claim 5, wherein a reinforcement layer is located between said intermediate backing and said backing layer.

25. The carpet of claim 17, wherein said reinforcement layer comprises a non-woven fiberglass layer.

26. The carpet of claim 5, wherein said adhesive or polymeric precoat layer or said intermediate layer or both comprise at least one styrene polymer.

27. The carpet of claim 5, wherein at least one adhesive is located on the backing layer.

28. The carpet of the claim 27, wherein said adhesive is a releasable adhesive.

29. The carpet of claim 6, wherein at least one adhesive is located on the backing layer.

30. The carpet of the claim 29, wherein said adhesive is a releasable adhesive.

31. The carpet of claim 27, wherein said adhesive is a styrene polymer based adhesive.

32. The carpet of claim 29, wherein said adhesive is a styrene polymer based adhesive.

33. A carpet comprising a primary backing having textile fibers extending upwardly from the primary backing and forming a surface;
at least one adhesive or polymeric precoat layer located below and affixed to a primary backing;
at least one intermediate backing located below an affixed or at least partially embedded into said adhesive or polymer pre-coat layer;
and at least one backing layer located below and affixed to the intermediate backing, wherein said adhesive or polymeric precoat layer comprises at least one styrene polymer and said backing layer or said intermediate layer or both comprises at least one polymeric foam layer.

34. The carpet of claim 33, wherein said polymeric foam layer is a polyurethane foam layer.

35. The carpet of claim 33, wherein said intermediate backing comprises at least one styrene polymer which is the same or different from said styrene polymer in said adhesive or polymeric precoat layer.

36. The surface covering of claim 1, wherein said surface covering is a floor covering.

37. The surface covering of claim 36, wherein said floor covering is a laminate floor covering.

38. The surface covering of claim 36, wherein said floor covering is a vinyl floor covering.

39. The surface covering of claim 36, wherein said floor covering is a thermoplastic plank.
